(19) United States
(12) Patent Application Publication
(10) Pub. No.: US 2011/0175269 A1
(43) Pub. Date: Jul. 21, 2011

(54) STABILIZER BUSH

(75) Inventors: Yuya HARADA, Okayama (JP); Keiichi FUNAKOSHI, Okayama (JP)

(73) Assignee: KURASHIKI KAKO CO., LTD., Okayama (JP)

(21) Appl. No.: 13/009,652

(22) Filed: Jan. 19, 2011

(30) Foreign Application Priority Data
Jan. 20, 2010 (JP) 2010-009662

(51) Int. Cl. F16F 1/36; F16F 7/00; B60G 21/055; B60G 11/22

(52) U.S. Cl. 267/293

(57) ABSTRACT

A stabilizer bush includes a cylindrical body section including a through-hole into which the stabilizer is inserted. In the body section, a slit is continuously formed from an outer circumferential surface of the body section toward an inner circumferential surface of the through-hole, and is formed so as to extend along a full length of the body section in a center axis direction of the through-hole. A direction of the slit from the outer circumferential surface toward the inner circumferential surface is set to a direction which does not pass through the center of the through-hole, and the slit is formed so as to extend parallel to a center axis of the through-hole.

### CROSS-REFERENCE TO RELATED APPLICATION

This application claims priority to Japanese Patent Application No. 2010-009662 filed on Jan. 20, 2010, the disclosure of which including the specification, the drawings, and the claims is hereby incorporated by reference in its entirety.

### BACKGROUND

The technique disclosed herein relates to a stabilizer bush for elastically supporting a stabilizer on a vehicle body.

A stabilizer is a torsion bar spring for controlling roll characteristics of a vehicle body. A middle section of the stabilizer is elastically supported on the vehicle body by a stabilizer bush including an elastic body. The stabilizer bush is generally in cylindrical shape with a through-hole into which the middle section of the stabilizer extending in a vehicle width direction is inserted. The stabilizer bush is sandwiched between a vehicle body member and a clamp attached and fixed to the vehicle body member, and therefore is attached to the vehicle body.

In the stabilizer bush, a slit, i.e., a cut end is provided, which is continuously formed from an inner circumferential surface of the through-hole toward an outer circumferential surface of the stabilizer bush, and which extends along a full length of the stabilizer bush in a through-hole axis direction. Such a slit is opened, and then the stabilizer is inserted into the through-hole.

In the stabilizer support structure configured as described above, the slit of the stabilizer bush may be relatively widely opened with the stabilizer being attached to the stabilizer bush. In addition, while a vehicle is running, the slit of the stabilizer bush may be gradually opened due to a repeated load input to the stabilizer bush. If the slit is relatively widely opened, e.g., a large movement of the stabilizer toward a position where the slit is formed while the vehicle is running may result in an increase in vehicle roll motion, and contact of the stabilizer with, e.g., the vehicle body member and the clamp (i.e., occurrence of so-called “metal touch”).

In order to reduce or prevent the opening of the slit, a technique has conventionally been proposed, in which a slit is formed so as to cross a through-hole axis, and to extend diagonal to the through-hole axis (see, e.g., Japanese Patent Publication No. H07-205632). Conversely, a technique has been proposed, in which a slit is linearly formed in an axial direction of a bush, whereas a through-hole is diagonally formed so as to cross the slit (see, e.g., Japanese Patent Publication No. H07-266835).

In, e.g., Japanese Patent Publication No. H09-269028 and Japanese Patent Publication No. 2000-46055, it has been proposed that, in a bush having a slit, a slit is formed in a zigzag pattern in an axial direction in order to reduce or prevent displacement of both side sections sandwiching the slit in the axial direction.

### SUMMARY

An example of a stabilizer bush disclosed herein is a stabilizer bush for elastically supporting a stabilizer on a vehicle body. The stabilizer bush includes a cylindrical body section including a through-hole into which the stabilizer is inserted.

In the body section, a slit for attaching the stabilizer to the stabilizer bush is continuously formed from an outer circumferential surface of the body section toward an inner circumferential surface of the body section, and is formed so as to extend along a full length of the body section in a center axis direction of the through-hole. A direction of the slit from the outer circumferential surface toward the inner circumferential surface is set to a direction which does not pass through the center of the through-hole, and the slit is formed so as to extend parallel to a center axis of the through-hole.

### BRIEF DESCRIPTION OF THE DRAWINGS

FIG. 1 is a perspective view of a stabilizer bush.

FIG. 2 is a perspective view schematically illustrating a support state of a stabilizer.

FIG. 3 is a front view of the stabilizer bush.

FIG. 4 is a side view of the stabilizer bush.

FIG. 5 is a bottom view of the stabilizer bush.

FIG. 6 is a front view illustrating the support state of the stabilizer by using the stabilizer bush illustrated in FIG. 1 etc.

FIG. 7 is a view corresponding to FIG. 6, which illustrates a support state of a stabilizer by using a stabilizer bush of a comparative example.

FIG. 8 is a front view illustrating another configuration of the stabilizer bush.

FIG. 9 is a front view illustrating still another configuration of the stabilizer bush.

FIG. 10 is a front view illustrating still another configuration of the stabilizer bush.

FIG. 11 is a front view illustrating still another configuration of the stabilizer bush.

### DETAILED DESCRIPTION

The inventors of the present disclosure have concluded that a study on an opening of a slit of a stabilizer bush shows that a significant advantage of reducing or preventing the opening of the slit is not realized even in the bush described in the foregoing patent documents, thereby causing metal touch.

In a configuration in which a through-hole axis and a silt are not parallel to each other as in the bush described in the foregoing patent documents, it is necessary to separately form the slit by cutting a bush removed from a mold by, e.g., a cutter. This results in disadvantages such as an increase in the number of process steps, and a complex manufacturing process of the stabilizer bush.

The technique disclosed herein has been made in view of the foregoing. It is an objective of the technique to provide an easily manufacturable stabilizer bush in which an opening of a slit is effectively reduced or prevented.

First, the inventors of the present disclosure have conducted a study on a manufacturing of a stabilizer bush. That is, in order to easily manufacture the stabilizer bush considering a formation of a slit, a through-hole axis and the slit are preferably parallel to each other. This is because the stabilizer bush including the through-hole is molded by using a core rod for forming a through-hole, and the molded stabilizer bush is pulled out from the core rod after a mold is opened (the core rod is actually moved and pulled out from the molded stabilizer bush). If a cutter is fixed to the core rod, the cutter can cut the molded stabilizer bush to form a slit simultaneously with the removal of the core rod from the molded stabilizer bush. In such a case, the slit is formed in an axial direction of the core rod, i.e., a direction parallel to the through-hole axis.

On the precondition that the slit is formed parallel to a center axis of the through-hole in order to facilitate the manufacturing of the stabilizer bush, the inventors of the present disclosure have conducted several studies on reduction or prevention of the opening of the slit. Consequently, the inventors of the present disclosure have concluded that, when a direction of the slit from an outer circumferential surface of the stabilizer bush toward an inner circumferential surface of the stabilizer bush is set to a direction which does not pass through the center of the through-hole, the opening of the slit is effectively reduced or prevented.

Specifically, the stabilizer bush disclosed herein is a stabilizer bush for elastically supporting a stabilizer on a vehicle body, and includes a cylindrical body section including a through-hole into which the stabilizer is inserted.

In the body section, a slit for attaching the stabilizer to the stabilizer bush is continuously formed from an outer circumferential surface of the body section toward an inner circumferential surface of the body section, and is formed so as to extend along a full length of the body section in a center axis direction of the through-hole. A direction of the slit from the outer circumferential surface toward the inner circumferential surface is set to a direction which does not pass through the center of the through-hole, and the slit is formed so as to extend parallel to a center axis of the through-hole.

According to the studies by the inventors of the present disclosure, when a vehicle is at rest, the stabilizer elastically supported by the stabilizer bush is in an initial state in which the center of the stabilizer is on the center axis of the through-hole of the stabilizer bush. On the other hand, while the vehicle is running, the stabilizer moves from the initial state in any directions including vertical and vehicle longitudinal directions. That is, the stabilizer radially moves about the center axis of the through-hole of the stabilizer bush.

Suppose that the direction of the slit from the outer circumferential surface of the stabilizer bush toward the inner circumferential surface of the stabilizer bush is set to a direction passing through the center of the through-hole. In such a case, the stabilizer radially moves about the center axis of the through-hole of the stabilizer bush as described above. Thus, when the stabilizer moves toward a position where the slit is formed, the slit formation section is pressed, and force acts to open the slit. If the slit extending direction is set to the direction passing through the center of the through-hole, a repeat of such a movement may result in a gradual opening of the slit.

In the foregoing configuration, the direction of the slit from the outer circumferential surface of the stabilizer bush toward the inner circumferential surface of the stabilizer bush is set to the direction which does not pass through the center of the through-hole. This reduces or prevents the opening of the slit even when the stabilizer moves toward the position where the slit is formed to press the slit formation section. Consequently, the opening of the slit is effectively reduced or prevented. In addition, the slit is formed so as to extend parallel to the center axis of the through-hole, and therefore the manufacturing of the stabilizer bush is simplified as described above.

The slit may be formed in a position displaced from the center of the through-hole in vertical and longitudinal directions perpendicular to the center axis direction in a state in which the body section is attached to the vehicle body to elastically support the stabilizer extending in a vehicle width direction.

The configuration in which the direction of the slit from the outer circumferential surface of the stabilizer bush toward the inner circumferential surface of the stabilizer bush is set to the direction which does not pass through the center of the through-hole is combined with the configuration in which the position where the slit is formed, i.e., the slit formation position in a circumferential direction of the through-hole is displaced in the vertical and longitudinal directions perpendicular to the center axis direction of the through-hole in the state in which the stabilizer bush is attached to the vehicle body. Such a combination more effectively reduces or prevents the opening of the slit. In addition, the findings of the inventors of the present disclosure show that the displacement of the slit position reduces an initial opening of the slit when attaching the stabilizer bush to the stabilizer.

The body section may be sandwiched between a vehicle body member and a clamp attached and fixed to the vehicle body member, and may be attached to the vehicle body. A region of the body section on the vehicle body member side relative to the center axis of the through-hole may be relatively thick, and a region of the body section on the clamp side may be relatively thin. The slit may be formed in the region on the vehicle body member side.

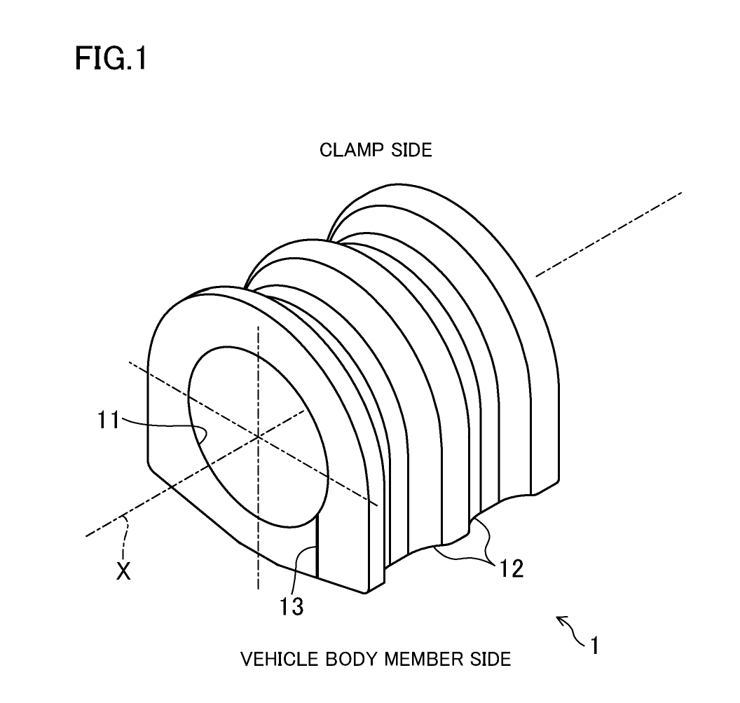

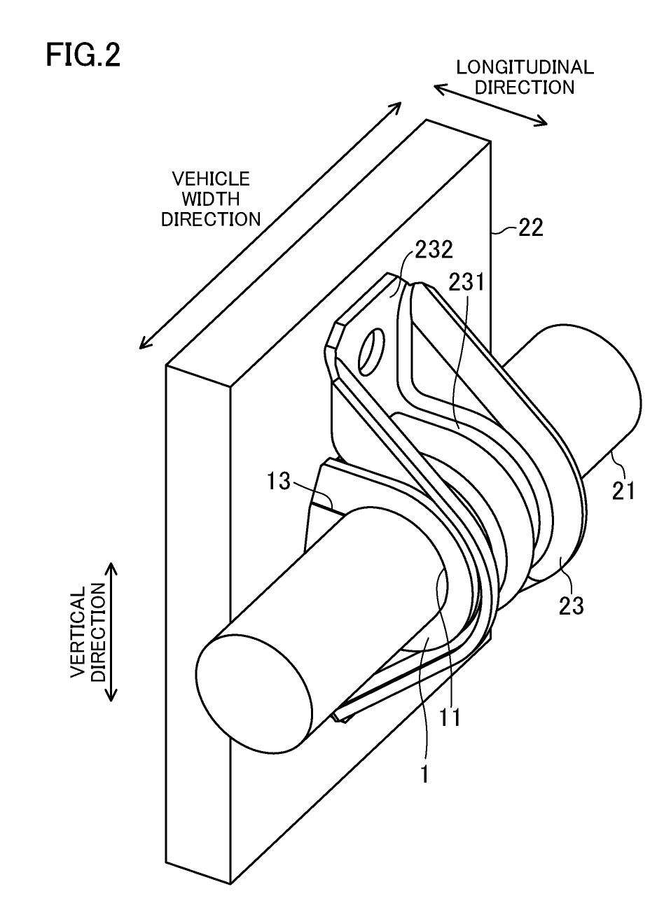

The slit is formed in the relatively thick region, and therefore the pressing and deformation of the slit formation region is reduced when the stabilizer moves toward the position of the slit. Consequently, the opening of the slit is further reduced or prevented. The configuration of the stabilizer bush will be described below in more detail with reference to the drawings. Note that the description below will be set forth merely for purposes of preferred examples in nature. FIG. 1 illustrates a stabilizer bush 1 for elastically supporting a stabilizer 21 on a vehicle body. As illustrated in FIG. 2, the stabilizer bush 1 includes a cylindrical body section having a through-hole 11 into which a middle section of the stabilizer 21 arranged so as to substantially extend in a vehicle width direction is inserted. The body section is a predetermined rubber elastic body. Note that, in the following description, the stabilizer bush 1 is not distinguished from the “body section” of the stabilizer bush 1, and is simply referred to as the “stabilizer bush 1.” In a state in which the stabilizer 21 is inserted into the through-hole 11, the stabilizer bush 1 is sandwiched between a vehicle body member 22 and a clamp 23 fixed to the vehicle body member 22 with bolts (not shown in the figure), and therefore is attached to the vehicle body. This allows the stabilizer bush 1 to elastically support the stabilizer 21 on the vehicle body. More specifically, the clamp 23 includes a substantially semicircular contact section 231 contacting an outer circumferential surface of the stabilizer bush 1; and bracket sections 232 which lead to ends of the contact section 231, and which are fixed to the vehicle body member 22 with the bolts. For the sake of the following description, in an attitude in which the stabilizer 21 is attached to the vehicle body, a vertical direction as viewed in FIG. 2 is referred to as a “vertical direction;” a direction extending from a front left side to a back right side as viewed in FIG. 2 is referred to as a “vehicle width direction;” and a direction extending from a front right side to a back left side as viewed in FIG. 2 is referred to as a “longitudinal direction (of the vehicle body).”

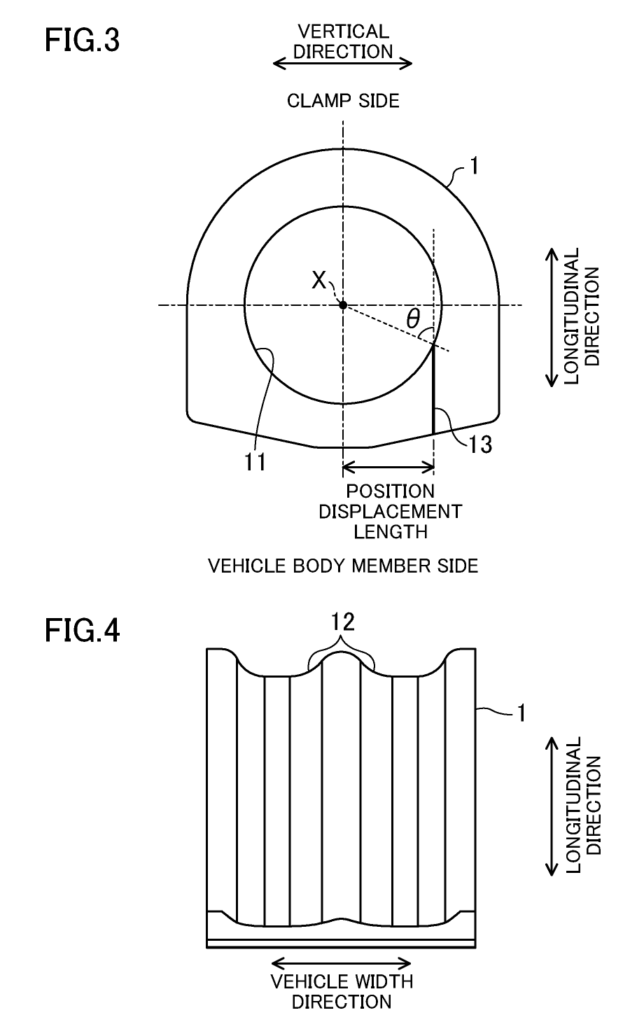

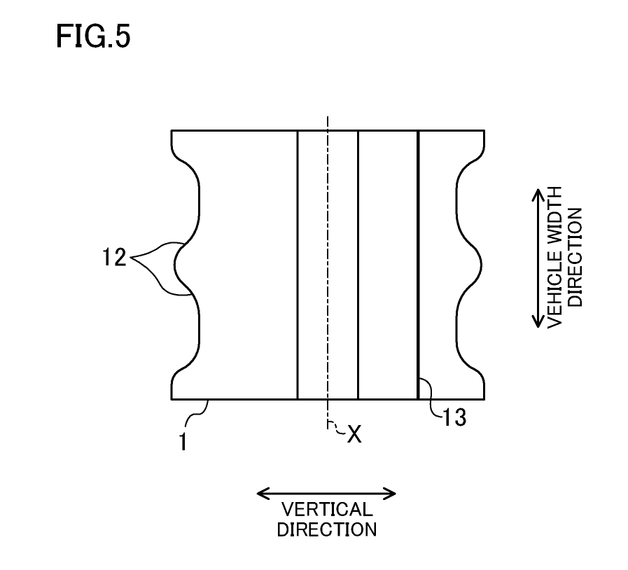

As more specifically illustrated in FIGS. 3-5, the stabilizer bush 1 is in cylindrical shape having a predetermined length in an axial direction of the stabilizer 21, i.e., the vehicle width direction (equivalent to the horizontal direction as viewed in FIG. 4, and the vertical direction as viewed in FIG. 5). As clearly illustrated in FIG. 3, as viewed from the front side of the stabilizer bush 1, the stabilizer bush 1 includes a substantially linear outer circumferential surface (i.e., a lower surface as viewed in FIG. 3) which is positioned on the vehicle body member 22 side facing the clamp 23 in the longitudinal direction; and a substantially U-shaped outer circumferential surface (i.e., a surface defined by upper and both side surfaces as viewed in FIG. 3) which is defined by a semicircular outer circumferential surface positioned along the through-hole 11 having a circular cross section on the clamp 23 side, and by linear outer circumferential surfaces connecting between each of ends of the semicircular outer circumferential surface and each of ends of the vehicle-body-member-side outer circumferential surface. Thus, the stabilizer bush 1 has a substantially semicircular arch-like shape. Note that the lower surface of the stabilizer bush 1 as viewed in FIG. 3 is hereinafter referred to as a “vehicle-body-member-side outer circumferential surface,” and a surface of the stabilizer bush 1, which is defined by the upper and both side surfaces as viewed in FIG. 3 is hereinafter referred to as a “clamp-side outer circumferential surface.”

As described above, the through-hole 11 has the circular cross section. Thus, it can be appreciated that the clamp-side outer circumferential surface is along the circular through-hole 11, whereas the vehicle-body-member-side outer circumferential surface is not along the circular through-hole 11. In other words, the thickness of the stabilizer bush 1 in a circumferential direction is not constant. That is, a region of the stabilizer bush 1 on the clamp side relative to a center axis X of the through-hole 11, i.e., an upper region as viewed in FIG. 3 is relatively thin; whereas a region of the stabilizer bush 1 on the vehicle body member side relative to the center axis X of the through-hole 11, i.e., a lower region as viewed in FIG. 3 is relatively thick. In particular, regions at lower right and left corners as viewed in FIG. 3 (i.e., connecting sections of the linear vehicle-body-member-side outer circumferential surface to the U-shaped clamp-side outer circumferential surface) are the thickest regions in the stabilizer bush 1.

As illustrated in, e.g., FIG. 4, in the clamp-side outer circumferential surface, grooves 12 which are inwardly recessed in a radial direction of the stabilizer bush 1 are formed so as to extend along the U-shaped clamp-side outer circumferential surface. Two grooves 12 are formed parallel to each other in an axial direction of the stabilizer bush 1 (i.e., vehicle width direction). On the other hand, although not specifically shown in the figure, a cross section of the contact section 231 of the clamp 23 in the vehicle width direction defines a recessed-raised shape so that the raised section of the contact section 231 is engaged with the groove 12 formed in the clamp-side outer circumferential surface. The groove 12 of the stabilizer bush 1 and the raised section of the recessed-raised contact section 231 are engaged with each other, and therefore a movement of the stabilizer bush 1 attached to the vehicle body member 22 in the axial direction of the stabilizer 21 can be reduced or prevented.

A slit 13 which is a cut end for attaching the stabilizer bush 1 so as to cover the middle section of the stabilizer 21, i.e., for inserting the middle section of the stabilizer 21 into the through-hole 11 is formed in the stabilizer bush 1.

The slit 13 is continuously formed from the outer circumferential surface of the stabilizer bush 1 (specifically the vehicle-body-member-side outer circumferential surface) toward an inner circumferential surface of the stabilizer bush 1, and opens in the outer and inner circumferential surfaces. The slit 13 allows a communication between an outside and an inside of the cylindrical stabilizer bush 1. As illustrated in FIG. 5, the slit 13 is formed so as to extend along a full length of the stabilizer bush 1 in the axial direction of the stabilizer bush 1. Thus, when attaching the stabilizer bush 1 so as to cover the middle section of the stabilizer 21, the through-hole 11 is opened along the slit 13 in the radial direction of the stabilizer bush 1, and then the middle section of the stabilizer 21 is inserted into the through-hole 11 through the opened slit 13.

A shape of the slit 13 and a position of the slit 13 in the stabilizer bush 1 will be described below in more detail with reference to the drawings. As illustrated in FIGS. 2 and 3, in a state in which the stabilizer bush 1 is attached to the vehicle body member 22, the slit 13 is formed in a position displaced from the center of the through-hole 11 (i.e., the center axis X) in the vertical direction. The displacement of the position of the slit 13 in the vertical direction results in displacement of the position of the slit 13 in the longitudinal direction. In addition, a direction from the outer circumferential surface of the stabilizer bush 1 toward the inner circumferential surface of the stabilizer bush 1 is set so as to be parallel to the longitudinal direction. Thus, as illustrated in FIG. 3, the direction of the slit 13 from the outer circumferential surface of the stabilizer bush 1 toward the inner circumferential surface of the stabilizer bush 1 is set to a direction which does not pass through the center of the through-hole 11. In other words, the slit 13 displaced to the right relative to the center axis X as viewed in FIG. 3 extends in the vertical direction of FIG. 3, and an extension of the slit 13 does not pass through the center axis X. The slit 13 is formed near the right or left corner in the vehicle-body-member-side region (i.e., the lower region as viewed in FIG. 3) of the stabilizer bush 1, meaning that the slit 13 is formed near the thickest region of the stabilizer bush 1.

As illustrated in FIG. 5, the slit 13 linearly extends in the axial direction of the stabilizer bush 1 so as to be parallel to a center axis direction of the through-hole 11.

A manufacturing method of the stabilizer bush 1 having the foregoing configuration will be briefly described. The stabilizer bush 1 includes the rubber elastic body, and therefore can be manufactured by vulcanization molding using a predetermined mold. Specifically, the stabilizer bush 1 is in cylindrical shape, and therefore can be molded by using a core rod for forming the through-hole 11, and a mold which is arranged so as to surround the core rod, and which can be disassembled into two pieces. A plurality of stabilizer bushes 1 may be simultaneously molded in an axial direction of the core rod.

When removing the molded stabilizer bush, it is necessary to open the two-piece mold, and to pull out the core rod from the molded stabilizer bush. A cutter is attached and fixed to a predetermined position of an end section of the core rod in a circumferential direction at a predetermined angle. Thus, when pulling out the core rod, the cutter cuts a predetermined section of the molded stabilizer bush, thereby forming a cut end, i.e., a slit 13. In the stabilizer bush 1 having the foregoing configuration, the slit 13 is linearly formed parallel to the center axis X of the through-hole 11 of the stabilizer bush 1, and therefore the slit 13 can be formed when removing the stabilizer bush 1 from the mold. This simplifies a manufacturing process of the stabilizer bush 1. As described above, particularly in the configuration in which the plurality of stabilizer bushes 1 are simultaneously molded in the axial direction of the core rod, when pulling out the core rod, the slit 13 is successively and efficiently formed in each of the stabilizer bushes 1.

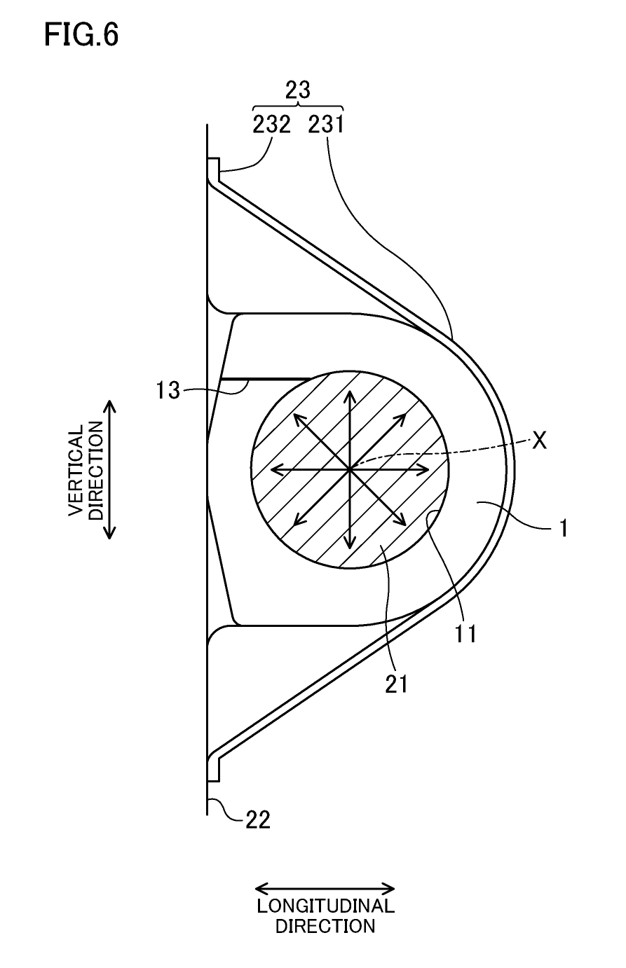

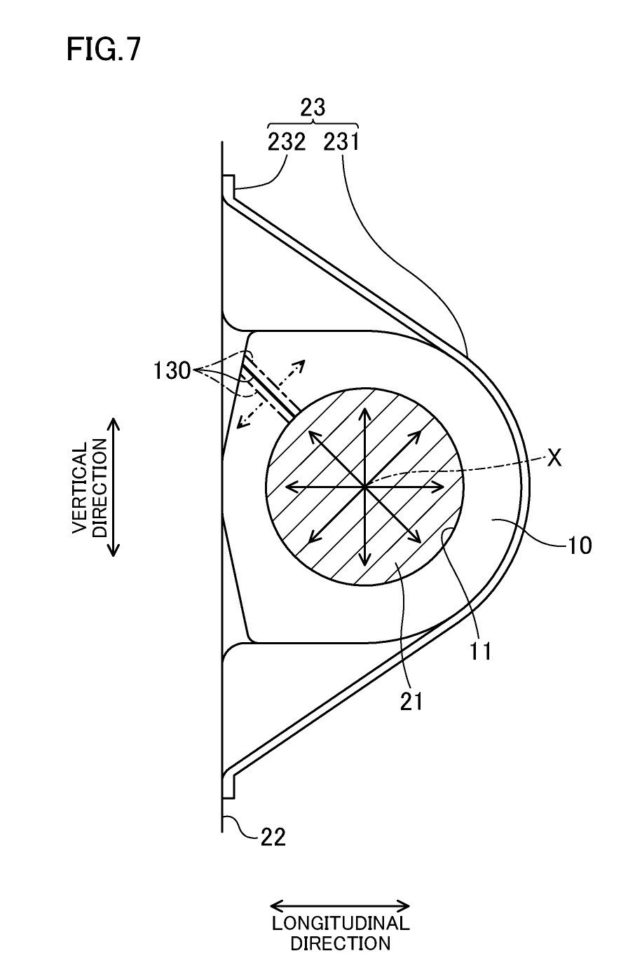

In the stabilizer bush 1 including the slit 13 having the foregoing features, the opening of the slit 13 can be reduced as compared to a conventional stabilizer bush. Such reduction will be described with reference to FIGS. 6 and 7. FIG. 6 is a front view illustrating a state in which the stabilizer bush 1 of the present embodiment supports the stabilizer 21. When the vehicle is at rest, the stabilizer 21 elastically supported by the stabilizer bush 1 is in an initial state in which the center of the stabilizer 21 is on the center axis X of the through-hole 11 of the stabilizer bush 1. On the other hand, while the vehicle is running, the stabilizer 21 can move from the initial state in any directions including the vertical and longitudinal directions depending on a load inputted to the stabilizer 21. That is, as indicated by arrows in FIG. 6, the stabilizer 21 can radially move about the center axis X of the through-hole 11 of the stabilizer bush 1.

As illustrated in FIG. 7, suppose that a direction of a slit 130 of a stabilizer bush 10 from an outer circumferential surface of the stabilizer bush 10 toward an inner circumferential surface of the stabilizer bush 10 is set so as to be parallel to a radial direction about the center of a through-hole 11. In such a configuration, an extending direction of the slit 130 is set to a direction passing through the center of the through-hole 11. The slit 130 is formed near a corner in a vehicle-body-member-side region of the stabilizer bush 10, and is displaced from the center of the through-hole 11 in the vertical and longitudinal directions. Although not shown in the figure, the slit 130 is formed so as to extend parallel to a center axis X of the through-hole 11.

As described above, the stabilizer 21 radially moves about the center of the through-hole 11 of the stabilizer bush 10. When the stabilizer 21 moves toward the position where the slit 130 is formed (toward an upper left side as viewed in FIG. 7), the formation region of the slit 130 in the stabilizer bush 10 is pressed, and then force acts to open the slit 130 as indicated by arrows in FIG. 7. Such force opens the slit 130 as indicated by hypothetical lines. Such a movement of the stabilizer 21 is repeated, thereby gradually opening the slit 130. That is, when the extending direction of the slit 130 is set to the direction passing through the center of the through-hole 11, the slit 130 gradually opens, and therefore the stabilizer 21 easily moves in the extending direction of the slit 130. Consequently, roll characteristic control capability is reduced, or metal touch is caused. Although not shown in the figure, even when setting the position where a slit is formed to a position different from that of FIG. 7 in a circumferential direction, if a slit extending direction is set to the direction passing through the center of the through-hole 11, the slit gradually opens for reasons similar to the foregoing.

On the other hand, in the stabilizer bush 1, the slit 13 is formed so that the direction from the outer circumferential surface of the stabilizer bush 1 toward the inner circumferential surface of the stabilizer bush 1 is set to the direction which does not pass through the center of the through-hole 11 as illustrated in FIG. 6. Thus, even if the stabilizer 21 radially moves toward the position where the slit 13 is formed about the center of the through-hole 11, and such a slit formation section is pressed, the force opening the slit 13 does not act on the position where the slit 13 is formed, thereby reducing or preventing the opening of the slit 13. The opening of the slit 13 is effectively reduced or prevented. Consequently, the roll characteristic control capability by the stabilizer 21 can be stably ensured for a long period of time, resulting in reduction or prevention of problems such as the metal touch.

The slit 13 is formed in the position displaced from the center of the through-hole 11 in the vertical and longitudinal directions with the stabilizer bush 1 being attached to the vehicle body. Such a configuration is combined with the configuration in which the direction of the slit 13 from the outer circumferential surface of the stabilizer bush 1 toward the inner circumferential surface of the stabilizer bush 1 is set to the direction which does not pass through the center of the through-hole 11, thereby more effectively reducing or preventing the opening of the slit 13. Further, a finding shows that the slit 13 is formed in the position displaced from the center of the through-hole 11 in the vertical and longitudinal directions, and therefore an initial opening of the slit 13 is reduced when attaching the stabilizer 21 to the stabilizer bush 1. This is also advantageous to the reduction or prevention of the opening of the slit 13 over time. Note that a displacement direction of the slit 13 may be any of upper and lower directions relative to the center of the through-hole 11 with the stabilizer bush 1 being attached to the stabilizer 21.

As described above, the slit 13 is formed in the vehicle-body-member-side region relative to the center axis X of the through-hole 11, and near the thickest region of the stabilizer bush 1. Thus, when the stabilizer 21 moves toward the position where the slit 13 is formed, the pressing and deformation of the slit formation section of the stabilizer bush 1 is reduced, thereby further reducing or preventing the opening of the slit 13. Consequently, the opening of the slit 13 is more effectively reduced or prevented.

A study has been conducted on a relationship between an angle θ formed by a line corresponding to a direction in which the slit 13 extends, and a line connecting between an opening position of the slit 13 in the inner circumferential surface of the stabilizer bush 1 and the center of the through-hole 11 (as indicated by a dashed line in FIG. 3); and reduction in opening of the slit 13. For example, if the slit 13 extends in the longitudinal direction, a shorter displacement length of the slit 13 from the center of the through-hole 11 in the vertical direction results in a smaller angle θ (i.e., a displacement length of 0 (zero) means an angle θ of 0), or a longer displacement length results in a larger angle θ. It can be appreciated that, when moving the stabilizer 21 toward the position where the slit 13 is formed, the smaller angle θ results in a greater force opening the slit 13, or the larger angle θ results in a smaller force. Thus, as illustrated in FIG. 3, the displacement length from the center of the through-hole 11 in the vertical direction is preferably increased for the slit 13 extending in the longitudinal direction because the opening of the slit 13 can be increasingly reduced. Although not shown in the figure, the slit 13 may be displaced to the maximum displacement position so as to be on a tangential line of the through-hole 11. Such an increase in displacement length of the slit 13 also means that the slit 13 is formed in the relatively thick region of the stabilizer bush 1.

In addition to the reduction or prevention of the opening of the slit 13 in the foregoing manner, the slit 13 is formed so as to extend parallel to the center axis X of the through-hole 11, and therefore the slit 13 can be formed simultaneously with the removal of the stabilizer bush 1 from the mold as described above. This reduces the number of process steps. Consequently, the manufacturing process of the stabilizer bush 1 is simplified.

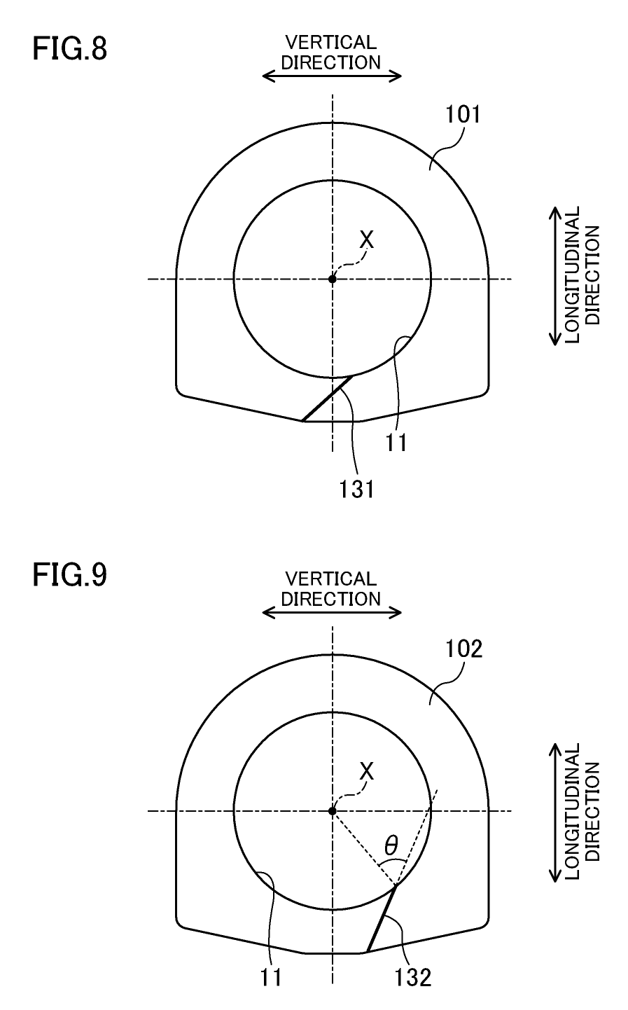

The slit shape and the slit formation position effective for reducing or preventing the opening of the slit are not limited to those illustrated in FIG. 3. Shapes and/or formation positions such as examples illustrated in, e.g., FIGS. 8-11 may be employed. Although only front views of stabilizer bushes are illustrated in FIGS. 8-11, slits 131-134 formed in such stabilizer bushes extend parallel to the center axis X.

First, as illustrated in FIG. 8, the slit 131 may be formed so that a direction of the slit 131 from an outer circumferential surface of a stabilizer bush 101 toward an inner circumferential surface of the stabilizer bush 101 is inclined to the longitudinal or vertical direction. In such a case, the slit 131 is in the same position as the center of a through-hole 11 in the vertical direction (i.e., the slit 131 is not displaced). However, an extending direction of the slit 131 is set to a direction which does not pass through the center of the through-hole 11, thereby reducing or preventing an opening of the slit 131 as in the foregoing. In addition, as in a stabilizer bush 102 illustrated in FIG. 9, the slit 132 may extend so as to be inclined to the longitudinal or vertical direction, and may be displaced from the center of a through-hole 11 in the vertical and longitudinal directions. An inclination direction of the slit 132 to the vertical or longitudinal direction is preferably set to a direction in which an angle 0 becomes larger. Thus, it is preferable that a direction of the slit 132 from an outer circumferential surface of the stabilizer bush 102 toward an inner circumferential surface of the stabilizer bush 102 is not a direction toward the center of the through-hole 11, but a direction away from the center of the through-hole 11 as illustrated in FIG. 9.

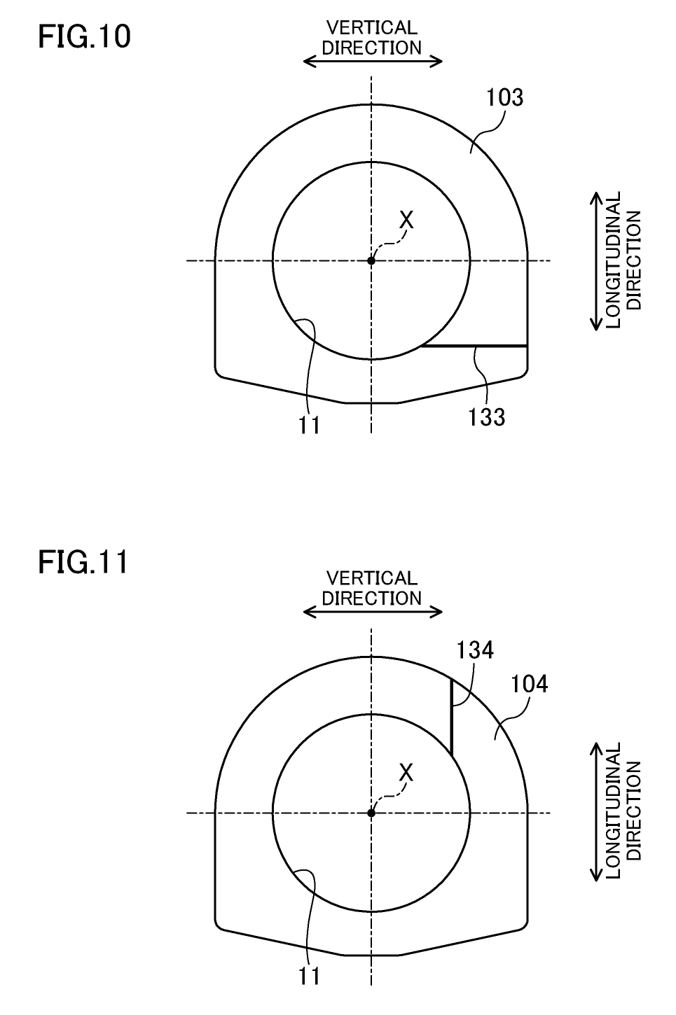

Further, as illustrated in FIG. 10, the slit 133 may open not in a vehicle-body-member-side outer circumferential surface of a stabilizer bush 103, but in a clamp-side outer circumferential surface of the stabilizer bush 103. That is, in the stabilizer bush 103, the slit 133 is formed in a position displaced from the center of a through-hole 11 in the longitudinal and vertical directions, and a direction of the slit 133 from the outer circumferential surface (specifically the clamp-side outer circumferential surface) of the stabilizer bush 103 toward an inner circumferential surface of the stabilizer bush 103 is set to the vertical direction. In the stabilizer bush 103, the extending direction of the slit 133 is also set to a direction which does not pass through the center of the through-hole 11, and this is advantageous to reduction or prevention of an opening of the slit 133. However, as described above, two grooves 12 are formed in the clamp-side outer circumferential surface, and therefore the slit 133 is formed in a section of the stabilizer bush 103, where a thickness varies in an axial direction (i.e., the vehicle width direction).

Further, as illustrated in FIG. 11, the slit 134 may be formed in a region of a stabilizer bush 104 on a clamp side relative to a center axis X of a through-hole 11. In such a case, an extending direction of the slit 134 is set to a direction which does not pass through the center of the through-hole 11 as described above, thereby effectively reducing or preventing an opening of the slit 134.

In addition, although not shown in the figure, the features of the slits 13 and 131-134 of the stabilizer bushes 1 and 101-104 illustrated in FIGS. 3 and 8-11 may be combined within a possible range as necessary.

Note that a shape of the stabilizer bush (body section) is not limited. The technique disclosed herein can be broadly applied for the cylindrical stabilizer bush having the through-hole 11.

What is claimed is:

1. A stabilizer bush for elastically supporting a stabilizer on a vehicle body, comprising:
a cylindrical body section including a through-hole into which the stabilizer is inserted,
wherein, in the body section, a slit for attaching the stabilizer to the stabilizer bush is continuously formed from an outer circumferential surface of the body section toward an inner circumferential surface of the body section, and is formed so as to extend along a full length of the body section in a center axis direction of the through-hole; and
a direction of the slit from the outer circumferential surface toward the inner circumferential surface is set to a direction which does not pass through the center of the through-hole, and the slit is formed so as to extend parallel to a center axis of the through-hole.

2. The stabilizer bush of claim 1, wherein
the slit is formed in a position displaced from the center of the through-hole in vertical and longitudinal directions perpendicular to the center axis direction in a state in which the body section is attached to the vehicle body to elastically support the stabilizer extending in a vehicle width direction.

3. The stabilizer bush of claim 1, wherein
the body section is sandwiched between a vehicle body member and a clamp attached and fixed to the vehicle body member, and is attached to the vehicle body;
a region of the body section on the vehicle body member side relative to the center axis of the through-hole is relatively thick, and a region of the body section on the clamp side is relatively thin; and
the slit is formed in the region on the vehicle body member side.
